(19) United States
(12) Patent Application Publication
(10) Pub. No.: US 2024/0017631 A1
(43) Pub. Date: Jan. 18, 2024

(54) ELECTRIFIED VEHICLE CHARGING DEVICE

(71) Applicant: TOYOTA JIDOSHA KABUSHIKI KAISHA, Toyota-shi (JP)

(72) Inventors: Yoichi ONISHI, Okazaki-shi (JP); Tetsuo Yamashita, Okazaki-shi (JP)

(73) Assignee: TOYOTA JIDOSHA KABUSHIKI KAISHA, Toyota-shi (JP)

(21) Appl. No.: 18/203,912

(22) Filed: May 31, 2023

(30) Foreign Application Priority Data
Jul. 13, 2022 (JP) 2022-112464

(51) Int. Cl. B60L 53/30

(52) U.S. Cl. CPC B60L 53/30

(57) ABSTRACT

An electrified vehicle charging device includes a main body and a charging connection unit. The charging connection unit includes a charging connection part that is attachable to and detachable from the main body, a charging connector that is attachable to and detachable from electrified vehicle, and a charging cable that connects the charging connection part and the charging connector. The charging connection unit includes a circuit for outputting a charging method signal indicating a charging method. When the charging connection part is connected to the main body, the main body receives the charging method signal from the charging connection unit, and supplies power to the charging connection unit in a charging method corresponding to the received charging method signal.

### CROSS-REFERENCE TO RELATED APPLICATION

This application claims priority to Japanese Patent Application No. 2022-112464 filed on Jul. 13, 2022, incorporated herein by reference in its entirety.

### BACKGROUND

### 1. Technical Field

Techniques disclosed herein relate to an electrified vehicle charging device.

### 2. Description of Related Art

An electrified vehicle charging device disclosed in Japanese Unexamined Patent Application Publication No. 2013-094040 (JP 2013-094040 A) includes a main body, a charging connector (that is, a charging gun), and a charging cable. The charging cable connects the main body and the charging connector. By connecting the charging connector to electrified vehicle, power can be supplied from the main body to electrified vehicle via the charging cable and the charging connector. As a result, the traveling battery mounted on electrified vehicle can be charged.

### SUMMARY

As a method of charging an electrified vehicle, there are various charging methods. Examples of the different charging methods include CHAdeMO (registered trademark) standard, CCS standard, and TESLA (registered trademark) standard. The charging voltage, the communication method for the vehicle, and the like are different for each charging method. In the present specification, an electrified vehicle charging device capable of changing a charging method is proposed.

An electrified vehicle charging device disclosed herein includes:
a main body; and
a charging connection unit.
   The charging connection unit includes:
a charging connection part that is attachable to and detachable from the main body;
a charging connector that is attachable to and detachable from the electrified vehicle, and
a charging cable that connects the charging connection part and the charging connector.
   The charging connection unit includes a circuit that outputs a charging method signal indicating a charging method.
   When the charging connection part is connected to the main body, the main body receives the charging method signal from the charging connection unit, and supplies power to the charging connection unit in a charging method corresponding to the received charging method signal.

In the electrified vehicle charging device, the charging connection unit is attachable to and detachable from the main body. Therefore, the charging connection unit having a charging connector with a shape corresponding to a desired charging method can be connected to the main body. The charging connection unit includes a circuit that outputs a charging method signal indicating a charging method. When the charging connection part is connected to the main body, the main body receives the charging method signal from the charging connection unit, and supplies power to the charging connection unit in a charging method corresponding to the received charging method signal. Thus, the main body can charge the electrified vehicle by the charging method corresponding to the shape of the charging connector. Therefore, in the electrified vehicle charging device, the charging method can be changed by changing the charging connection unit connected to the main body.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view of an electrified vehicle charging device;

FIG. 2 is a side view of an electrified vehicle charging device;

FIG. 3 is a view showing an arrangement of contact terminals on a side surface of a protrusion part;

FIG. 4 is a partial cross-sectional view of a charging connection part;

FIG. 5 is a schematic diagram of an electrified vehicle charging device.

### DETAILED DESCRIPTION OF EMBODIMENTS

Hereinafter, the configuration of the technology disclosed in the present specification will be described for each item following item 1.

### (Item 2)

electrified vehicle charging device wherein according to Item 1
At least one of the charging connection part and the main body has a charging relay,
When the charging connection part is not connected to the main body, the charging relay is turned off,
When the charging connection part is connected to the main body, the charging relay is turned on and the main body is electrically connected to the charging cable via the charging relay.

### (Item 3)

electrified vehicle charging device wherein of items 1 or 2
A power supply connection part detachably attachable to the main body,
A power supply connector that is attachable to and detachable from another electrified vehicle separate from an electrified vehicle to which the charging connector is connected,
Power supply connection unit having a power supply cable connecting the power supply connection part and the power supply connector
and further comprising:
The main body receives the power supply from the power supply connection unit,
It is portable.

### (Item 4)

electrified vehicle charging device wherein described in Item 3
The power supply connection unit includes a circuit for outputting a power supply method signal indicating a power supply method,
When the power supply connection part is connected to the main body, the main body receives the power supply method signal from the power supply connection unit, and receives power supply from the power supply connection unit in a method corresponding to the received power supply method signal.

### (Item 5)

electrified vehicle charging device wherein according to item 3 or 4
At least one of the power supply connection part and the main body has a power supply relay,
When the power supply connection part is not connected to the main body, the power supply relay is turned off,
When the power supply connection part is connected to the main body, the power supply relay is turned on and the power supply cable is electrically connected to the main body via the power supply relay.

### (Item 6)

electrified vehicle charging device wherein according to any one of items 1 to 5
The main body has an engaging part constituted by a groove or a hole,
The charging connection part has a sliding part insertable into the engaging part by sliding along the longitudinal direction of the engaging part,
The slide part is electrically connected to the main body inside the engagement part.

According to electrified vehicle charging device of Item 2, it is possible to prevent the main body from being electrically connected to the charging connector when the main body and the charging connection part are incompletely connected.

electrified vehicle charging device of Item 3 is portable. Since the charging connection part and the power supply connection part can be removed from the main body, electrified vehicle charging device can be easily carried.

According to electrified vehicle charging device of Item 4, power can be appropriately supplied from electrified vehicle connected to the power supply connection unit.

According to electrified vehicle charging device of Item 5, it is possible to prevent the main body from being electrically connected to the power supply connector when the main body and the power supply connection part are incompletely connected.

According to electrified vehicle charging device of Item 6, since the electric contact is provided inside the engaging part, unintended contacting of the object with the electric contact can be suppressed.

### EXAMPLES

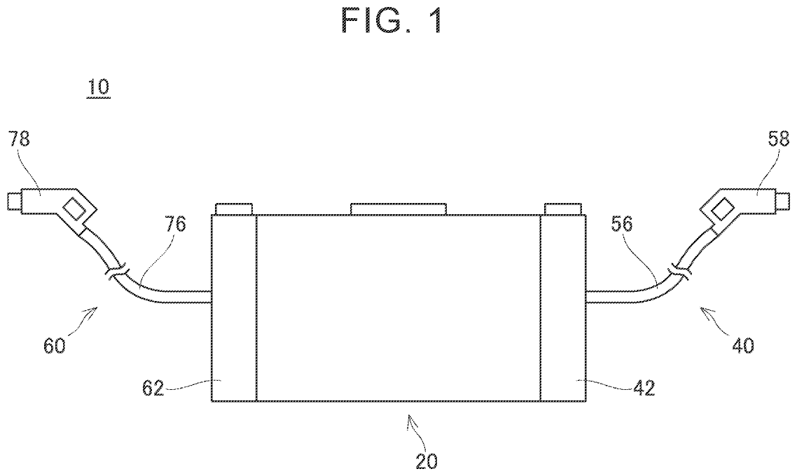

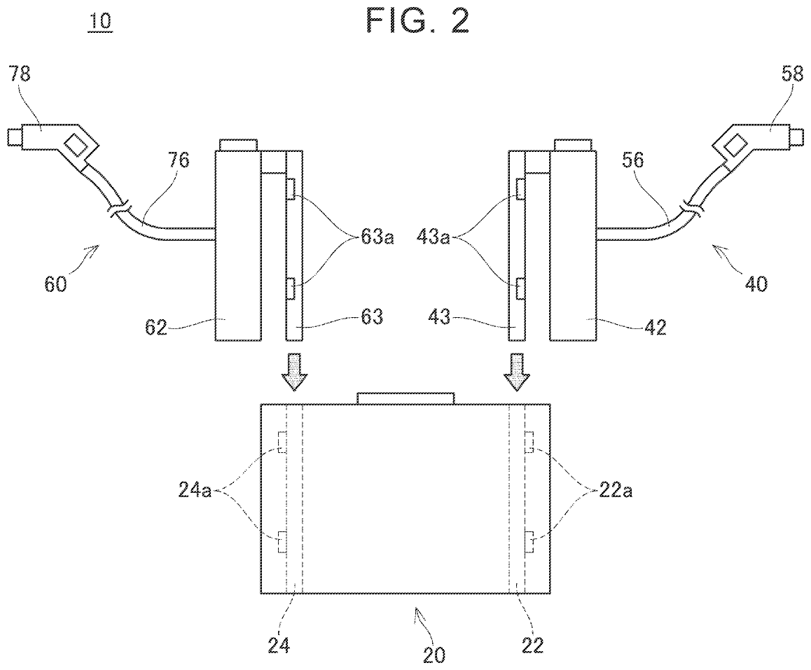

electrified vehicle charging device 10 shown in FIG. 1 is portable. electrified vehicle charging device 10 is connected to two electrified vehicle. Electrified vehicle charging device 10 charges the running battery of the other electrified vehicle by supplying the electric power supplied from the running battery of one electrified vehicle to the running battery of the other electrified vehicle. Electrified vehicle charging device 10 includes a main body 20, a charging connection unit 40, and a power supply connection unit 60. As illustrated in FIGS. 1 and 2, the charging connection unit 40 and the power supply connection unit 60 can be attached to and detached from the main body 20.

As shown in FIG. 2, slit grooves 22 and 24 are provided on the side surface of the main body 20. The slit grooves 22 and 24 extend in the vertical direction. A plurality of contact terminals 22a are provided in the slit groove 22. A plurality of contact terminals 24a are provided in the slit groove 24.

The charging connection unit 40 includes a charging connection part 42, a charging cable 56, and a charging connector 58. A charging connection part 42 is connected to one end of the charging cable 56, and a charging connector 58 is connected to the other end of the charging cable 56. The charging connection part 42 is a part to be attached to and detached from the main body 20. The charging connector 58 is attached to and detached from electrified vehicle. As shown in FIG. 2, the charging connection part 42 has a protrusion part 43. A plurality of contact terminals 43a are provided on the side surface of the protrusion part 43. The protrusion part 43 can be inserted into the slit groove 22 by sliding the protrusion part 43 along the longitudinal direction of the slit groove 22 (that is, the up-down direction). When the protrusion part 43 is inserted into the slit groove 22, the charging connection part 42 is attached to the main body 20 as shown in FIG. 1. Further, when the protrusion part 43 is inserted into the slit groove 22, the contact terminals 22a are contacted with the corresponding contact terminals 43a. When the contact terminal 22a contacts the contact terminal 43a, the main body 20 and the charging connection unit 40 are electrically connected to each other. When the charging connector 58 is connected to electrified vehicle while the charging connection part 42 is attached to the main body 20, electric power can be supplied from the main body 20 to electrified vehicle.

The power supply connection unit 60 includes a power supply connection part 62, a power supply cable 76, and a power supply connector 78. A power supply connection part 62 is connected to one end of the power supply cable 76, and a power supply connector 78 is connected to the other end of the power supply cable 76. The power supply connection part 62 is a part to be attached to and detached from the main body 20. The power supply connector 78 is attached to and detached from electrified vehicle. As shown in FIG. 2, the power supply connection part 62 has a protrusion part 63. A plurality of contact terminals 63a are provided on the side surface of the protrusion part 63. By sliding the protrusion part 63 along the longitudinal direction of the slit groove 24 (that is, the up-down direction), the protrusion part 63 can be inserted into the slit groove 24. When the protrusion part 63 is inserted into the slit groove 24, the power supply connection part 62 is attached to the main body 20 as shown in FIG. 1. Further, when the protrusion part 63 is inserted into the slit groove 24, the contact terminals 24a are contacted with the corresponding contact terminals 63a. When the contact terminal 24a contacts the contact terminal 63a, the main body 20 and the power supply connection unit 60 are electrically connected to each other. When the power supply connector 78 is connected to electrified vehicle while the power supply connection part 62 is attached to the main body 20, power can be supplied to the main body 20 from electrified vehicle.

As described above, by providing the contact terminal 22a, 24a in the slit grooves 22 and 24, it is possible to suppress unintended contact of the object with the contact terminal 22a, 24a. In FIG. 2, the engagement part engaged with the protrusion parts 43 and 63 is constituted by the slit grooves 22 and 24, but the engagement part engaged with the protrusion parts 43 and 63 may be constituted by a hole or the like.

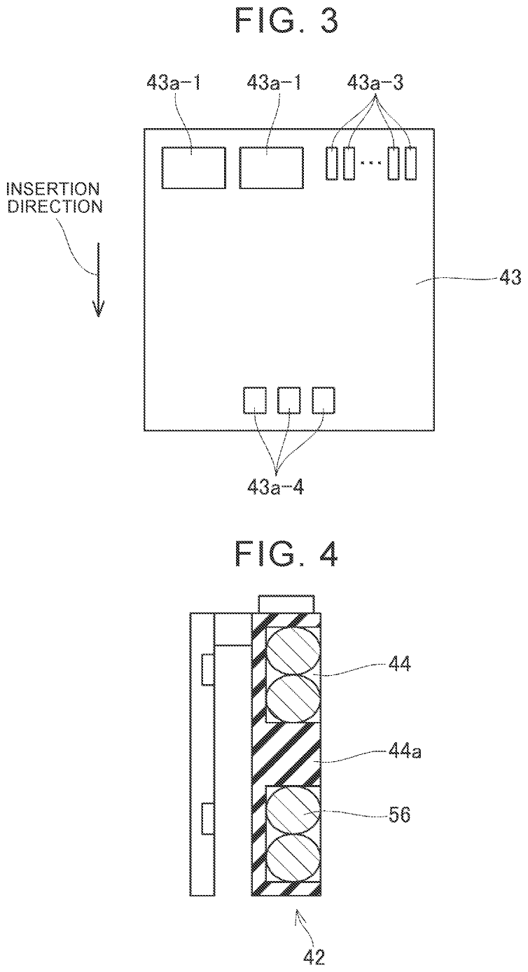

FIG. 3 shows the arrangement of the contact terminals 43a on the side surfaces of the protrusion parts 43 of the charging connection parts 42. The reference numeral 43a-1, 43a-2 denotes a contact terminal to which a charge-output voltage (that is, a high voltage) is applied. The contact terminal 43a-1, 43a-2 is a contact terminal connected to a DC-DC converter described later. The reference numeral 43a-3 denotes a contact terminal to which a signal communicating with electrified vehicle is outputted. The sign 43a-4 is a contact terminal to which a voltage of a lower voltage band (for example, 0 to 12V) is applied. The contact terminal 43a-4 is a contact terminal for operating the relays 45 and 46 and the signal output circuit 54 described later. The contact terminal 43a-1, 43a-2, 43a-3 is electrically connected to the charging connector 58, while the contact terminal 43a-4 is not electrically connected to the charging connector 58. The contact terminal 43a-1, 43a-2, 43a-3 is disposed on an upper part of a side surface of the protrusion part 43, and is arranged in a lateral direction (that is, a direction perpendicular to a direction in which the protrusion part 43 is inserted into and removed from the slit groove 22). Therefore, when the protrusion part 43 is inserted into and removed from the slit groove 22, the contact terminal 43a-1, 43a-2, 43a-3 is prevented from contacting the contact terminal on the main body 20 that does not correspond to itself. This prevents an abnormal voltage from being output to the charging connector 58. Further, when the protrusion part 43 is inserted into and removed from the slit groove 22, the contact terminal 43a-4 may be contacted with a contact terminal on the main body 20 side that does not correspond to itself (for example, a contact terminal on the main body 20 side corresponding to the contact terminal 43a-1, 43a-2, 43a-3). However, the contact terminal 43a-4 is not electrically connected to the charging connector 58. Therefore, even if the contact terminal 43a-4 contacts the contact terminal on the main body 20 that does not correspond to the contact terminal itself, an abnormal voltage is not outputted to the charging connector. The contact terminal 63a provided on the protrusion part 63 of the power supply connection part 62 is also arranged in the same manner as in FIG. 3.

As described above, the charging connection unit 40 and the power supply connection unit 60 are attachable to and detachable from the main body 20. Therefore, when electrified vehicle charging device 10 is transported, the main body 20, the charging connection unit 40, and the power supply connection unit 60 can be transported separately, and electrified vehicle charging device 10 can be easily transported. Further, by removing the charging connection unit 40 and the power supply connection unit 60 from the main body electrified vehicle charging device 10 can be easily housed. As shown in FIG. 4, the charging connection part 42 has a cable accommodation space 44. A shaft part 44a is provided at the center of the cable accommodation space 44. By winding the charging cable 56 on the shaft part 44a, the charging cable 56 can be accommodated in the cable accommodation space 44. With this configuration, the transportability of the charging connection unit 40 is improved. Further, although not shown, the power supply connection part 62 also has a similar cable accommodation space. This improves the transportability of the power supply connection unit 60.

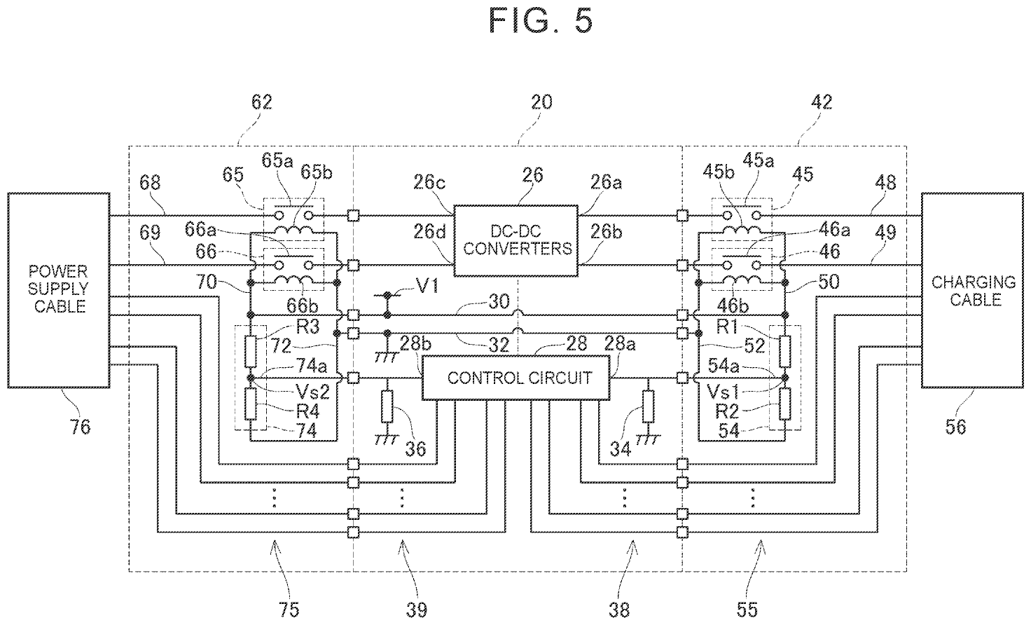

FIG. 5 shows an electric circuit provided inside the main body 20, the charging connection part 42, and the power supply connection part 62. In FIG. 5, the terminals connecting the wiring of the main body 20 and the wiring of the charging connection part 42 are constituted by contact terminals 22a, 43a shown in FIG. 2. In FIG. 5, the terminals connecting the wiring of the main body 20 and the wiring of the power supply connection part 62 are constituted by the contact terminal 24a, 63a shown in FIG. 2.

As illustrated in FIG. 5, the main body 20 includes a DC-DC converter 26, a control circuit 28, a power supply wire 30, a ground wire 32, and resistors 34 and 36. DC-DC converters 26 have an output terminal 26a, 26b and an input terminal 26c, 26d. DC-DC converters 26 boost the DC voltage applied between the input terminals 26c, 26d, and output the boosted DC voltage from the output terminals 26a, 26b. A relatively lower DC-voltage V1 is applied to the power supply wire 30. In this embodiment, the voltage V1 is 12V. The ground wire 32 is connected to the ground (that is, 0V). The control circuit 28 is constituted by a microcontroller or the like. The control circuit 28 is connected to DC-DC converter 26 and controls DC-DC converter 26. The control circuit 28 has a detection terminal 28a, 28b. The detection terminal 28a is connected to the ground via the resistor 34. The detection terminal 28b is connected to the ground via the resistor 36. A plurality of communication wires 38 and 39 are connected to the control circuit 28. The plurality of communication wires 38 are communication wires for the control circuit 28 to communicate with the charge-side electrified vehicle. The plurality of communication wires 39 are communication wires for the control circuit 28 to communicate with the power supply-side electrified vehicle.

The charging connection unit 40 that can be attached to the main body 20 is provided for each charging method. That is, there are a charging connection unit 40 for charging CHAdeMO (registered trademark) standard-compliant electrified vehicle, a charging connection unit 40 for charging CCS standard-compliant electrified vehicle, a charging connection unit 40 for charging TESLA (registered trademark) standard-compliant electrified vehicle, and the like. The shape of the charging connector 58 of each charging connection unit 40 varies depending on the charging method. In addition, the internal circuits of the respective charging connection parts 42 are partially different depending on the charging method. Similarly, the power supply connection unit 60 that can be attached to the main body 20 is provided for each power supply system. The shape of the power supply connector 78 of each power supply connection unit 60 varies depending on the power supply system. In addition, the internal circuits of the respective power supply connection parts 62 are partially different depending on the power supply system.

As illustrated in FIG. 5, the charging connection part 42 includes a relay 45, a relay 46, charging lines 48 and 49, a power supply wire 50, a ground wire 52, a signal output circuit 54, and a plurality of communication wires 55. The charging wires 48, 49 and the plurality of communication wires 55 extend through the charging cable 56 to the charging connector 58. When the charging connector 58 is connected to electrified vehicle, these wires are connected to electrified vehicle. Each communication wire 55 can be connected to a corresponding communication wire 38 of the main body 20 via a corresponding contact terminal. The power supply wire 50 can be connected to the power supply wire 30 of the main body 20 via a contact terminal. The ground wire 52 can be connected to the ground wire 32 of the main body 20 via a contact terminal. When the charging connection part 42 is connected to the main body 20, a voltage V1 is applied to the power supply wire 50, and the ground wire 52 is grounded.

The relays 45 have contact parts 45a and coil parts 45b. One end of the contact part 45a can be connected to the output terminal 26a of DC-DC converter 26 via the contact terminal. The other end of the contact part 45a is connected to the charging wire 48. One end of the coil part 45b is connected to the ground wire 52. The other end of the coil part 45b is connected to the power supply wire 50. The relays 46 have contact parts 46a and coil parts 46b. One end of the contact part 46a can be connected to the output terminal 26b of DC-DC converter 26 via the contact terminal. The other end of the contact part 46a is connected to the charging wire 49. One end of the coil part 46b is connected to the ground wire 52. The other end of the coil part 46b is connected to the power supply wire 50. In a state where the charging connection part 42 is not connected to the main body 20, the relays 45 and 46 are turned off. When the charging connection part 42 is connected to the main body 20, a voltage V1 is applied to the power supply wire 50, and the ground wire 52 is grounded. Then, a current flows through the coil part 45b, the contact part 45a is turned on, a current flows through the coil part 46b, and the contact part 46a is turned on. In this way, the relays 45, 46 are turned on when the charging connection part 42 is attached to the main body 20. When the relays 45 and 46 are turned on, the main body 20 is connected to the charging wires 48 and 49 (that is, the charging cable 56).

The signal output circuit 54 includes a resistor R1, R2 and a detection wire 54a. One end of the resistor R1 is connected to the power supply wire 50. The other end of the resistor R1 is connected to one end of the resistor R2. The other end of the resistor R2 is connected to the ground wire 52. One end of the detection wire 54a is connected to a connection part between the resistor R1 and the resistor R2. The other end of the detection wire 54a can be connected to the detection terminal 28a of the control circuit 28 via a contact terminal. When the charging connection part 42 is not connected to the main body 20, the detection terminal 28a of the control circuit 28 is grounded via the resistor 34. In this condition, the potential of the detection terminal 28a is 0V. When the charging connection part 42 is connected to the main body 20, the detection wire 54a is connected to the detection terminal 28a. Further, as described above, when the charging connection part 42 is connected to the main body 20, a voltage V1 is applied to the power supply wire 50, and the ground wire 52 is grounded. Then, a current flows through the series-circuit of the resistor R1 and the resistor R2. Therefore, the potential of the detection wire 54a (that is, the potential of the detection terminal 28a) becomes a potential Vs' obtained by dividing the voltage V1 by the resistor R1 and the resistor R2. That is, the potential of the detection wire 54a becomes a potential Vs' satisfying the relation of Vs1=V1·R2/(R1+R2). Therefore, the control circuit 28 detects the potential Vs1 as the potential of the detection terminal 28a. The control circuit 28 determines whether or not the charging connection part 42 is attached to the main body according to whether or not the potential of the detection terminal 28a is 0V.

The resistor of the resistor R1, R2 varies depending on the charging method compliant with the charging connection unit 40. In one embodiment, the charging connection unit 40 compliant with CHAdeMO standard may have a resistor R1, R2 of 200 kΩ and 100 kΩ, respectively. Here, 4V is outputted as the potential Vs1. In addition, in one embodiment, in the charging connection unit 40 compliant with CCS standard, the resistor R1, R2 can be set to 300 kΩ and 100 kΩ, respectively. Here, 3V is outputted as the potential Vs1. In addition, in one embodiment, in the charging connection unit 40 compliant with TESLA (registered trademark) standard, the resistor R1, R2 may be 500 kΩ and 100 kΩ, respectively. Here, 2V is outputted as the potential Vs1. As described above, the signal output circuit 54 outputs the voltage signal Vs1 (that is, the charging method signal) corresponding to the charging method compliant with the charging connection unit 40. Therefore, when the charging connection unit 40 is attached to the main body 20, the control circuit 28 detects the charging method based on the potential Vs' applied to the detection terminal 28a.

As illustrated in FIG. 5, the power supply connection part 62 includes a relay a relay 66, power supply wires 68 and 69, a power supply wire 70, a ground wire 72, a signal output circuit 74, and a plurality of communication wires 75. The power supply wires 68, 69 and the plurality of communication wires 75 extend through the power supply cable 76 to the power supply connector 78. When the power supply connector 78 is connected to electrified vehicle, these wires are connected to electrified vehicle. Each communication wire can be connected to a corresponding communication wire 39 of the main body 20 via a corresponding contact terminal. The power supply wire 70 can be connected to the power supply wire 30 of the main body 20 via a contact terminal. The ground wire 72 can be connected to the ground wire 32 of the main body 20 via a contact terminal. When the power supply connection part 62 is connected to the main body 20, a voltage V1 is applied to the power supply wire 70, and the ground wire 72 is grounded.

The relays 65 have contact parts 65a and coil parts 65b. One end of the contact part 65a can be connected to the input terminal 26c of DC-DC converter 26 via the contact terminal. The other end of the contact part 65a is connected to the power supply wire 68. One end of the coil part 65b is connected to the ground wire 72. The other end of the coil part 65b is connected to the power supply wire 70. The relays 66 have contact parts 66a and coil parts 66b. One end of the contact part 66a can be connected to the input terminal 26d of DC-DC converter 26 via the contact terminal. The other end of the contact part 66a is connected to the power supply wire 69. One end of the coil part 66b is connected to the ground wire 72. The other end of the coil part 66b is connected to the power supply wire 70. In a state where the power supply connection part 62 is not connected to the main body 20, the relays 65 and 66 are turned off. When the power supply connection part 62 is connected to the main body 20, a voltage V1 is applied to the power supply wire 70, and the ground wire 72 is grounded. Then, a current flows through the coil part 65b, the contact part 65a is turned on, a current flows through the coil part 66b, and the contact part 66a is turned on. Thus, the relays 65, 66 are turned on when the power supply connection part 62 is attached to the main body 20. When the relays 65 and 66 are turned on, the main body 20 is connected to the power supply wires 68 and 69 (that is, the power supply cable 76).

The signal output circuit 74 includes a resistor R3, R4 and a detection wire 74a. One end of the resistor R3 is connected to the power supply wire 70. The other end of the resistor R3 is connected to one end of the resistor R4. The other end of the resistor R4 is connected to the ground wire 72. One end of the detection wire 74a is connected to a connection part between the resistor R3 and the resistor R4. The other end of the detection wire 74a can be connected to the detection terminal 28b of the control circuit 28 via a contact terminal. When the power supply connection part 62 is not connected to the main body 20, the detection terminal 28b of the control circuit 28 is grounded via the resistor 36. In this condition, the potential of the detection terminal 28b is 0V. When the power supply connection part 62 is connected to the main body 20, the detection wire 74a is connected to the detection terminal 28b. Further, as described above, when the power supply connection part 62 is connected to the main body 20, a voltage V1 is applied to the power supply wire and the ground wire 72 is grounded. Then, a current flows through the series-circuit of the resistor R3 and the resistor R4. Therefore, the potential of the detection wire 74a (that is, the potential of the detection terminal 28b) becomes a potential Vs2 obtained by dividing the voltage V1 by the resistor R3 and the resistor R4. That is, the potential of the detection wire 74a becomes a potential Vs2 satisfying the relation of Vs2=V1·R4/(R3+R4). Therefore, the control circuit 28 detects the potential Vs2 as the potential of the detection terminal 28b. The control circuit 28 determines whether or not the power supply connection part 62 is attached to the main body 20 according to whether or not the potential of the detection terminal 28b is 0V.

The resistance of the resistor R3, R4 varies depending on the power supply system to which the power supply connection unit 60 complies. Therefore, the signal output circuit 74 outputs a voltage signal Vs2 (i.e., a power supply system signal) corresponding to the power supply system compliant with the power supply connection unit 60. Therefore, when the power supply connection unit 60 is attached to the main body 20, the control circuit 28 detects the power supply system based on the potential Vs2 applied to the detection terminal 28b.

Next, the operation of electrified vehicle charging device 10 will be described. When electrified vehicle charging device 10 is used, first, the charging connection unit 40 and the power supply connection unit 60 are attached to the main body 20. When the charging connection unit 40 and the power supply connection unit 60 are connected to the main body 20, the relays 45, 46, 65, and 66 are turned on. Next, the charging connector 58 is connected to an electrified vehicle (hereinafter, referred to as a charging-side electrified vehicle), and the power supply connector 78 is connected to an electrified vehicle (hereinafter, referred to as a power supply-side electrified vehicle) that differs from the charging-side electrified vehicle. Next, the user performs a predetermined operation to cause electrified vehicle charging device 10 to perform a charging operation. When the charging operation is started, the control circuit 28 detects the potential Vs2 of the detection terminal 28b, thereby specifying the power supply system compliant with the power supply connection unit 60. Next, the control circuit 28 communicates with the power supply-side electrified vehicle via the communication wires 39 and 75. At this time, the control circuit 28 performs communication using a communication protocol corresponding to the power supply method specified based on the potential Vs2. Accordingly, the control circuit 28 turns on the inside of the power supply electrified vehicle and outputs a DC voltage between the power supply wires 68 and 69 from the traveling battery of the power supply electrified vehicle. The DC voltage supplied from the driving battery of the power supply-side electrified vehicle is applied between the input terminals 26c, 26d of DC-DC converters 26. In addition, the control circuit 28 detects the potential Vs1 of the detection terminal 28a, thereby specifying the charging method compliant with the charging connection unit 40. Next, the control circuit 28 communicates with the charge-side electrified vehicle via the communication wires 38 and 55. At this time, the control circuit 28 performs communication using a communication protocol corresponding to the charge method specified based on the potential Vs1. Thus, the control circuit 28 turns on the internal-switch of the charging-side electrified vehicle, and electrically connects the charging wires 48 and 49 to the running battery of the charging-side electrified vehicle. The control circuit 28 then operates DC-DC converters 26. DC-DC converters 26 boost the voltage applied between the input terminals 26c, 26d (that is, the voltage supplied from the power supply-side electrified vehicle), and apply the boosted voltage between the output terminals 26a, 26b. Therefore, the output-voltage of DC-DC converter 26 is applied to the running battery of the charging-side electrified vehicle, and the running battery is charged. The control circuit 28 controls the voltage outputted from DC-DC converters 26 to a voltage determined by the charge method specified based on the potential Vs1. Therefore, an appropriate voltage is applied to the traveling battery of the charging-side electrified vehicle, and the traveling battery of the charging-side electrified vehicle is appropriately charged. As described above, according to electrified vehicle charging device 10, the running battery of the charging-side electrified vehicle can be charged using the electric power supplied from the power supply-side electrified vehicle.

In the above-described embodiment, the signal output circuits 54 and 74 are constituted by a series circuit of two resistors. However, the signal output circuits 54 and 74 may be any circuits as long as they can output a signal corresponding to a charging method or a power supply method. For example, the signal output circuits 54 and 74 may be constituted by IC chips or the like.

Further, in the above-described embodiment, the relays 45 and 46 are turned off in a state where the charging connection part 42 is not attached to the main body 20, and the relays 45 and 46 are turned on when the charging connection part 42 is connected to the main body 20. Therefore, it is possible to prevent a high voltage from being erroneously output from the main body 20 to the charging connector 58 in an operation of attaching the charging connection part 42 to the main body 20 or the like. The relays 45 and 46 may be provided in the main body 20 or may be provided in both the main body 20 and the charging connection part 42. Further, in the above-described embodiment, the relays 65 and 66 are turned off in a state where the power supply connection part 62 is not attached to the main body 20, and the relays 65 and 66 are turned on when the power supply connection part 62 is connected to the main body 20. Therefore, it is possible to prevent a high voltage from being erroneously output from the main body 20 to the power supply connector 78 in an operation of attaching the power supply connection part 62 to the main body 20. The relays 65 and 66 may be provided in the main body 20 or may be provided in both the main body and the power supply connection part 62.

Further, in the above-described embodiment, the portable electrified vehicle charging device has been described. However, the techniques described herein may be applied to a stationary electrified vehicle charging device. For example, the technique described in the present specification may be applied to a stationary electrified vehicle charging device that converts AC power into DC power and outputs the DC power. In this case, no power supply connection unit is required. For this reason, electrified vehicle charging device may be configured by the main body and a charging connection unit that is detachable from the main body. By replacing the charging connection unit, electrified vehicle charging device can charge electrified vehicle of various charging systems.

Although the embodiment has been described in detail above, the embodiment is merely an example and does not limit the scope of claims. The techniques described in the claims include various modifications and alternations of the specific examples illustrated above. The technical elements described in the present specification or the drawings exhibit technical usefulness alone or in various combinations, and are not limited to the combinations described in the claims at the time of filing. In addition, the techniques illustrated in the present specification or the drawings achieve a plurality of objectives at the same time, and achieving one of the objectives itself has technical usefulness.

What is claimed is:

1. An electrified vehicle charging device comprising:
a main body; and
a charging connection unit including
a charging connection part that is attachable to and detachable from the main body,
a charging connector that is attachable to and detachable from the electrified vehicle, and
a charging cable that connects the charging connection part and the charging connector, wherein:
the charging connection unit includes a circuit that outputs a charging method signal indicating a charging method; and
when the charging connection part is connected to the main body, the main body receives the charging method signal from the charging connection unit, and supplies power to the charging connection unit in a charging method corresponding to the received charging method signal.

2. The electrified vehicle charging device according to claim 1, wherein:
at least one of the charging connection part and the main body has a charging relay;
when the charging connection part is not connected to the main body, the charging relay is turned off; and
when the charging connection part is connected to the main body, the charging relay is turned on and the main body is electrically connected to the charging cable via the charging relay.

3. The electrified vehicle charging device according to claim 1, the electrified vehicle charging device further comprising
a power supply connection unit including:
a power supply connection part that is attachable to and detachable from the main body;
a power supply connector that is attachable to and detachable from another electrified vehicle separate from an electrified vehicle to which the charging connector is connected; and
a power supply cable that connects the power supply connection part and the power supply connector, wherein
the main body receives power supply from the power supply connection unit.

4. The electrified vehicle charging device according to claim 3, wherein:
the power supply connection unit includes a circuit that outputs a power supply method signal indicating a power supply method; and
when the power supply connection part is connected to the main body, the main body receives the power supply method signal from the power supply connection unit, and receives power supply from the power supply connection unit in a method corresponding to the received power supply method signal.

5. The electrified vehicle charging device according to claim 3, wherein:
at least one of the power supply connection part and the main body includes a power supply relay;
when the power supply connection part is not connected to the main body, the power supply relay is turned off; and
when the power supply connection part is connected to the main body, the power supply relay is turned on and the power supply cable is electrically connected to the main body via the power supply relay.

6. The electrified vehicle charging device according to claim 1, wherein:
the main body includes an engaging part constituted by a groove or a hole;
the charging connection part includes a sliding part insertable into the engaging part by sliding along a longitudinal direction of the engaging part; and
the slide part is electrically connected to the main body inside the engagement part.
